(19) United States
(12) Patent Application Publication
(10) Pub. No.: US 2021/0163363 A1
(43) Pub. Date: Jun. 3, 2021

(54) CERAMIC MATERIAL, METHOD OF PRODUCTION, LAYER AND LAYER SYSTEM

(71) Applicant: Siemens Aktiengesellschaft, Munich (DE)

(72) Inventors: Arturo Flores Renteria, Berlin (DE); Werner Stamm, Mülheim an der Ruhr (DE)

(73) Assignee: Siemens Aktiengesellschaft, Munich (DE)

(21) Appl. No.: 16/770,606

(22) PCT Filed: Nov. 29, 2018
(86) PCT No.: PCT/EP2018/083005

§ 371 Date: Jun. 7, 2020

(30) Foreign Application Priority Data
Dec. 29, 2017 (DE) 10 2017 223 879.8

(51) Int. Cl. C04B 35/488; C23C 28/00; C04B 41/50; C04B 41/87; C04B 37/02

(52) U.S. Cl. CPC C04B 35/488; C23C 28/3215; C04B 41/5042; C04B 41/87; C04B 37/025; C04B 2237/36; C04B 2235/3246; C04B 2237/348; C04B 2235/3225; C04B 2237/405; C04B 37/026

(57) ABSTRACT

A ceramic material including at least erbium oxide (Er2O3)-stabilized zirconium oxide (ZrO2). The erbium oxide-stabilized zirconium oxide can be used as ceramic thermal barrier layer. Crack resistance of such ceramic materials is considerably increased by using erbium oxide-stabilized zirconium oxide.

### CROSS REFERENCE TO RELATED APPLICATIONS

This application is the US National Stage of International Application No. PCT/EP2018/083005 filed 29 Nov. 2018, and claims the benefit thereof. The International Application claims the benefit of German Application No. DE 10 2017 223 879.8 filed 29 Dec. 2017. All of the applications are incorporated by reference herein in their entirety.

### FIELD OF INVENTION

The invention relates to erbium oxide-stabilized zirconium oxide which can, in particular, be used as ceramic thermal barrier layer.

### BACKGROUND OF INVENTION

Modern gas turbines having a high efficiency require thermal barrier layers which should not have any pronounced phase transitions in the entire operating range or temperature range. In addition, the crack resistance should not be adversely affected by thermal stress and sintering associated therewith. The thermal barrier layers used today, i.e. gadolinium zirconate or a zirconium oxide stabilized with 33.5 mol % of Y₂O₃, which crystallize in a fluorite or face centered cubic structure, have a crack resistance which is only about ⅓ of that of zirconium oxide partially stabilized with 4 mol % of Y₂O₃ (YSZ).

In the case of the 4 mol % YSZ system known hitherto, which on the basis of most recent knowledge may possibly be capable of use up to about 1623 K, the crack resistance increases with increasing sintering temperature, with the crack resistance being a factor of 3 higher than that of face centered cubic systems such as 13 mol % YSZ or gadolinium zirconate because of the tetragonally distorted lattice. In the case of the systems, the operating states then have to be matched to the tolerable stress states of the ceramic, so that the energy liberation rate of the system is not sufficient to propagate the cracks in the ceramic.

### SUMMARY OF INVENTION

It is therefore an object of the invention to solve the abovementioned problem.

The object is achieved by a ceramic material as claimed, a process as claimed, a ceramic layer as claimed and a ceramic layer system as claimed.

### BRIEF DESCRIPTION OF THE DRAWINGS

FIG. 1 and FIG. 2 represent working examples of the invention.

### DETAILED DESCRIPTION OF INVENTION

Some systems having a purely cubic structure do not have any phase transitions in wide temperature ranges. The crack resistance is reduced with increased sintering. The system composed of 13 mol % YSZ (fully stabilized zirconium oxide) and 33.5 mol % YSZ crystallizes out in the cubic phase. Additions of erbium zirconate (Er₂O₃) stabilize the systems (ErSZ) in a phase having a low symmetry and an increased crack resistance. The crack resistance is significantly increased by reducing the symmetry of the system and is maintained even under presintering or is even increased in, for example, the system 4 mol % YSZ. The new system is simple to melt and is stabilized in a phase which has a low symmetry compared to the cubic phase. In final alloy compositions composed of the three elements ZrO₂, Er₂O₃, Y₂O₃, the composition composed of ZrO₂ and Er₂O₃ and also ZrO₂ and Y₂O₃ should preferably firstly be partially alloyed, the melted alloys are milled again and then blended to give a homogeneous mixture and subsequently finally homogeneously melted in an electric furnace.

The following compositions are particularly suitable for this purpose: ErSZ: (2-6) mol % Er₂O₃ in ZrO₂, preferably 3.5 mol % erbium oxide (Er₂O₃), 8-30 mol % ErSZ and 48YSZ (2ZrO₂×Y₂O₃), preferably 15 mol % erbium oxide-stabilized zirconium oxide, 8-30 mol % ErSZ and yttrium-stabilized zirconium oxide containing 13-20 mol % of Y₂O₃ as stabilizer for ZrO₂, preferably 15 mol % yttrium oxide-stabilized zirconium oxide.

The ceramic preferably consists of Er₂O₃, Y₂O₃ and ZrO₂.

The zirconium oxide can be partially or fully stabilized; it is preferably fully stabilized.

The inventive step does not lie in the application or manufacture of the layer itself but in the selection of the concentration range to be set. The material having a cubic starting structure is stabilized by the additions in a low-symmetry structure (tetragonal).

The process comprises using at least 10% by volume and not more than 90% by volume of erbium oxide (Er₂O₃)-stabilized zirconium oxide (ZrO₂) for the partial melt and accordingly from 90% by volume to 10% by volume of Y₂O₃—ZrO₂.

The following compositions are preferred for the partial melt:—fully stabilized zirconium oxide, in particular Y₂O₃-stabilized zirconium oxide, very particularly preferably zirconium oxide stabilized by 33.5 mol % of Y₂O₃, —Y₂O₃-stabilized zirconium oxide (ZrO₂), in particular zirconium oxide (ZrO₂) stabilized by 13-20 mol % of Y₂O₃, and also—from 2 mol %-6 mol %, in particular 3.5 mol %, erbium oxide (Er₂O₃)-stabilized zirconium oxide (ZrO₂),—8 mol %-30 mol %, in particular 15 mol %, erbium oxide (Er₂O₃)-stabilized zirconium oxide (ZrO₂).

This partial melt of Er₂O₃ and ZrO₂ can be combined in any way.

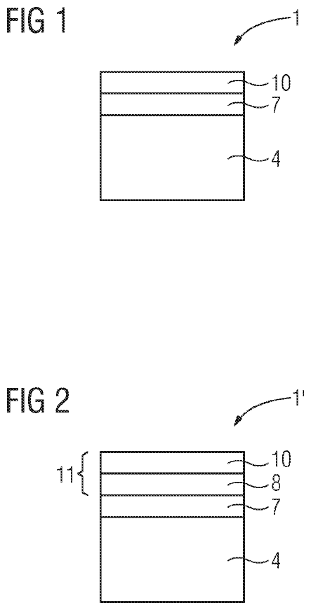

FIG. 1 shows, in simplified form, the layer system 1 which comprises a metallic substrate 4 or a ceramic substrate, in particular composed of CMC.

An either metallic or ceramic bonding layer 7, in particular an NiCoCrAlY layer in the case of a metallic substrate, is present on the substrate 4, and on top of this bonding layer there is at least one ceramic layer 10 based on the ceramic material according to the invention.

FIG. 2 shows a further variant 1′ in which the ceramic layer 11 is made up of two layers and in addition to the bonding layer has a ceramic layer 8 located underneath in order to match the coefficient of thermal expansion.

This layer 8 can in this case be zirconium oxide which is stabilized with yttrium oxide and does not comprise any erbium oxide.

1. A ceramic material, comprising:
at least erbium oxide (Er₂O₃)-stabilized zirconium oxide (ZrO₂), in particular consisting thereof.

2. The ceramic material as claimed in claim 1, comprising:
at least: a zirconium oxide (ZrO₂) stabilized with erbium oxide (Er₂O₃) and yttrium oxide (Y₂O₃),
in particular consisting thereof,
and very particularly preferably largely or entirely in a tetragonal phase.

3. The ceramic material as claimed in claim 2, comprising:
erbium oxide (Er₂O₃)-stabilized zirconium oxide (ZrO₂) and fully stabilized zirconium oxide, in particular Y₂O₃-stabilized zirconium oxide,
very particularly preferably zirconium oxide stabilized by 33.5 mol % of Y₂O₃,
in particular consisting thereof.

4. The ceramic material as claimed in claim 2, comprising:
erbium oxide (Er₂O₃)-stabilized zirconium oxide (ZrO₂) and stabilized zirconium oxide (ZrO₂),
in particular Y₂O₃-stabilized zirconium oxide (ZrO₂),
very particularly preferably zirconium oxide (ZrO₂) stabilized by 13-20 mol % of Y₂O₃,
in particular consisting thereof.

5. The ceramic material as claimed in claim 1, comprising:
from 2 mol % to 6 mol %,
in particular 3.5 mol %, of erbium oxide (Er₂O₃)-stabilized zirconium oxide (ZrO₂).

6. The ceramic material as claimed in claim 1, comprising:
8 mol %-30 mol %,
in particular 15 mol %, of erbium oxide (Er₂O₃)-stabilized zirconium oxide (ZrO₂).

7. The ceramic material as claimed in claim 1,
wherein partial melts of erbium oxide (Er₂O₃)-stabilized zirconium oxide (ZrO₂) and yttrium oxide (Y₂O₃)-stabilized zirconium oxide (ZrO₂),
in particular consisting thereof,
which have been melted or sintered together have been used for the ceramic material,
in particular used for the only two partial melts which after final melting comprise a homogeneous mixture.

8. A process for producing a ceramic material as claimed in claim 2, wherein partial melts of:
Er₂O₃-stabilized zirconium oxide and
stabilized zirconium oxide,
in particular Y₂O₃-stabilized zirconium oxide,
are used by these being melted together or sintered together.

9. The process as claimed in claim 8,
wherein partial melts of erbium oxide (Er₂O₃)-stabilized zirconium oxide (ZrO₂) and fully stabilized zirconium oxide, in particular zirconium oxide fully stabilized by Y₂O₃, very particularly preferably zirconium oxide stabilized by 33.5 mol % of Y₂O₃, are used.

10. The process as claimed in claim 8,
wherein partial melts of erbium oxide (Er₂O₃)-stabilized zirconium oxide (ZrO₂) and 13-20 mol % Y₂O₃-stabilized zirconium oxide (ZrO₂), in particular 15 mol % stabilized zirconium oxide (ZrO₂), are used.

11. The process as claimed in claim 8,
wherein 2 mol %-6 mol %, in particular 3.5 mol %, erbium oxide (Er₂O₃)-stabilized zirconium oxide (ZrO₂) is used for the partial melt.

12. The process as claimed in claim 8, one or more of claim 8,
wherein 8 mol %-30 mol %, in particular 15 mol %, erbium oxide (Er₂O₃)-stabilized zirconium oxide (ZrO₂) is used for the partial melt.

13. The process as claimed claim 8,
wherein at least 10% by volume and not more than 90% by volume of erbium oxide (Er₂O₃)-stabilized zirconium oxide (ZrO₂) is used for the partial melt.

14. A layer, comprising:
a ceramic material as claimed in claim 1.

15. A layer system, comprising:
either a metallic substrate or a substrate composed of CMC
and/or a bonding layer, either metallic or ceramic, in particular based on NiCoCrAlY, and
at least one layer as claimed in claim 14.
